(19) United States
(12) Patent Application Publication
(10) Pub. No.: US 2007/0051824 A1
(43) Pub. Date: Mar. 8, 2007

(54) Nozzles for electrospray ionization and methods of fabricating them

(76) Inventors: Olle Larsson, Stockholm (SE); Toni Sigmundsson, Hallstahammar (SE); Michael Read, Uppsala (SE); Ove Ohman, Uppsala (SE)

Correspondence Address: WILSON SONSINI GOODRICH & ROSATI, 650 PAGE MILL ROAD, PALO ALTO, CA, 94304-1050, US

(21) Appl. No.: 10/546,117

(22) PCT Filed: Feb. 19, 2004
(86) PCT No.: PCT/SE04/00229

§ 371 Date: Oct. 25, 2006

(30) Foreign Application Priority Data
Feb. 19, 2003 (SE) 0300454-6

(51) Int. Cl. B05B 5/025

(52) U.S. Cl. 239/3; 239/690; 239/704; 239/589

(57) ABSTRACT

A nozzle chip (3) for ejecting a liquid such as in an electrospray device is built from a substrate chip having grooves (5, 7) on a top surface. A lid (25) is attached to the top surface closing the grooves to form channels one of which has an open outlet end (9). At the outlet end a nozzle is formed at or attached and it has an outlet opening from which the liquid is to be ejected. Alignment recesses (13, 15) are made at edges of the substrate chip and they are accurately positioned in relation to the outlet opening, the alignment recesses allowing an accurate mounting of nozzle chip giving the outlet opening of the nozzle a reproducible position in the device where it is to be used. At the outlet end a recess (17) in the substrate chip can be provided and the nozzle can then be located in the recess to mechanically protect it.

### RELATED APPLICATION

This application claims priority and benefit from Swedish patent application No. 0300454-6, filed Feb. 19, 2003, the entire teachings of which are incorporated herein by reference.

### TECHNICAL FIELD

The present invention relates to nozzles for ejecting a liquid, in particular for electrospray ionization, to chips carrying nozzles and to methods of manufacturing nozzles and nozzle chips.

### BACKGROUND

Mass spectrometry is one of the most powerful methods used for analyzing liquid phases, see e.g. Andrew J. de Mello: “Chip-MS: Coupling the large with the small”, Lab on a Chip, 2002, Vol. 1, 7N-12N. An important advance in liquid sampling method for mass spectrometry analysis includes the development of the electrospray technique. In electrospray ionization a flowing analyte stream is forced through a capillary biased to high potential in relation to the analyzer. The high electric field produced causes the liquid when exiting the capillary to form a “Taylor cone” which is enriched with positive ions at the exit, i.e. at the tip of the cone. Positively charged droplets are formed and expelled from the tip of the Taylor cone by the electric field to form a mist of small droplets. The droplets move in the electric field and a pressure gradient towards the analyzer. During this migration of the droplets “Coulomb explosion” and evaporation act to reduce the size of the droplets, ultimately resulting in fully desolvated ions.

The nozzle used at the exit opening for the liquid to be analyzed should allow the creation of a stable Taylor cone having its tip located at a well-defined place. A finer electrospray nozzle gives a more stable and more efficient electrospray process. In particular the very outlet opening of the nozzle should be well defined having smooth surfaces without cutting burrs and having a well defined geometric position in relation to the analyzer. In the case where the liquid is water or a similar liquid the outer surfaces at the outlet opening can be given a hydrophobic coating. It can prevent the liquid from spreading along the outer surfaces of the outlet opening, thereby allowing efficient formation of droplets and electrospray.

Nozzles for electrospray ionization based on small microfluidic chips have also been described in e.g. Jun Kameoka, Harold G. Craighead, Hongwei Zhang and Jack Henion: “A polymeric microfluidic chip for CE/MS determination of small molecules”, Anal. Chem. Vol. 73, May 1, 2001, pp. 1935-1941, Jun Kameoka, Reid Orth, Bojan Ilic, David Czapiewski, Tim Wachs and H. G. Craighead: “An electrospray ionization source of integration with microfluidics”, Anal. Chem., 2002, pages EST: 5 A-E, Véronique Gobry, Jan van Oostrum, Marco Martinelli, Tatiana C. Rohner, Frédéric Reymond, Joël S. Rossier and Hubert H. Girault: “Microfabricated polymer injector for direct mass spectrometry coupling”, Proteonics 2002, Vol. 2, pp. 405-412, and Jenny Wen, Yuehe Lin, Fan xiang, Dean W. Matson, Herold R. Udseth and Richard D. Smith: “Microfabricated isoelectric focusing device for direct electrospray ionization-mass spectrometry”, Electrophoresis 2000, Vol. 21, pp. 191-197.

In published International patent application No. WO 00/30167 a polymer based electrospray nozzle structure for mass spectrometry is disclosed, in which patterned polymer layers are applied to a silicon substrate to produce an outlet channel forming the nozzle between the applied polymer layers. In published International patent application No. WO 02/05590 a soft lithography process is used for producing microfabricated emitters for electrospray ionization mass spectrometry. In U.S. Pat. No. 6,245,227 an integrated monolithic microfabricated electrospray device is disclosed comprising a basically rotationally symmetric nozzle made in silicon.

### SUMMARY OF THE INVENTION

It is an object of the invention to provide nozzles for ejecting a liquid, in particular for electrospray ionization, and methods for production thereof allowing the nozzles to be produced in large volumes and at low costs.

It is another object of the invention to provide nozzles for ejecting a liquid, in particular for electrospray ionization, that can be manufactured by mainly replication, moulding and/or laminating methods applied to polymer materials.

Generally, in manufacturing nozzles and chips carrying nozzles for electrospray ionization a substrate or carrier is produced using a replication or moulding method. The substrate has channels on one of its surfaces. The channels are closed by applying a lid that can comprise a flexible, relatively thin polymer sheet to said surface. In particular an exit channel ends at an exit opening that is not closed by the lid. At the exit opening either a nozzle has already been formed in the moulding of the substrate or a separate nozzle part is attached after applying the polymer sheet. The substrate can be provided with alignment means, such as recesses or projections at its edges and/or on said surface, the alignment means having accurately defined positions in relation to the exit opening and/or the outlet opening in the nozzle.

Also, in manufacturing the nozzles, a multitude of chips can be produced from a large substrate plate to which a large polymer sheet or plate, e.g. a flexible, thin polymer film or laminate, is applied. The obtained structure is then split to form the individual chips, this simultaneous production of a multitude of chips reducing the manufacturing cost per obtained chip. In the splitting operation alignment recesses can be made available from the edges of the chips and also the structure at the nozzles can be modified, such as to produce a spout having three walls projecting in a recess formed in the moulding of the substrate plate.

A metal tip at the nozzle of a chip can be provided and may be obtained by applying a patterned metal layer to the thin polymer sheet before applying it to the substrate or by applying a separate metal foil part. The metal tip can have an outermost triangular part having a free point and concave sides connected at the free point. The concave sides can give sufficiently small angles at critical places allowing that no liquid will pass along a wall from which the free tip extends and that all liquid will be dispensed from a well defined point. The metal material can also be connected to a potential necessary for the electrospray process.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a plan view of a segment of a substrate plate comprising a multitude of areas that after splitting will form individual substrate chips for edge emitting nozzle chips,

FIG. 2 is a fragmentary sectional view of the substrate plate of FIG. 1 having a sheet laminated to its top surface,

FIG. 3 is a plan view similar to that of FIG. 1 of a segment of a substrate plate comprising a multitude of areas that after splitting will form individual substrate chips for surface emitting nozzle chips,

FIG. 4 is a perspective view of a segment of the substrate plate shown in FIG. 1 having a sheet laminated to its top surface,

FIG. 5 is a fragmentary perspective view of a substrate chip for an edge emitting device,

FIG. 6a is a view similar to that of FIG. 4 of a substrate chip having a nozzle of an alternative shape,

FIG. 6b is a fragmentary perspective view of a finished chip of an edge emitting device having a polymer lid recessed at the nozzle,

FIGS. 7, 8, 9a and 9b are views similar to that of FIG. 4 of a substrate chip having a nozzle of still alternative shapes,

FIG. 10 is a fragmentary sectional view similar to that of FIG. 2 showing material portions removed in the initial steps of an operation for splitting a substrate with applied lid to form individual nozzle chips,

FIG. 11 is a fragmentary perspective view of parts used for manufacturing a nozzle chip having a metal tip,

FIG. 12 is a fragmentary plan view of a nozzle chip according to FIG. 11,

FIG. 13 is a fragmentary sectional view of the nozzle chip according to FIG. 11,

FIG. 14 is fragmentary perspective view of parts used in an alternative method of manufacturing a nozzle chip having a metal tip,

FIG. 15 is a fragmentary perspective view of parts used for manufacturing a nozzle chip having a freely extending metal tip,

FIG. 16 is a fragmentary sectional view of the nozzle chip according to FIG. 15,

FIG. 17 is a fragmentary perspective view of a nozzle chip of a surface emitting device,

FIG. 18 is a fragmentary sectional view of the nozzle chip of FIG. 17,

FIG. 19 is a fragmentary perspective view of a substrate and a lid used for manufacturing nozzle chips of surface emitting devices,

FIGS. 20a-20c are fragmentary sectional views illustrating steps in manufacturing individual polymer nozzles for surface emitting devices, and

FIGS. 21a and 21b are fragmentary sectional views illustrating steps in manufacturing individual

metal nozzles for surface emitting devices.

### DETAILED DESCRIPTION

Now different structures of and devices for nozzle chips for ejecting a liquid, such as for electrospray ionization, will be described and methods of manufacturing them. The nozzle chips basically comprise three parts, a substrate chip, a lid applied to a top surface of the substrate chip, and a nozzle. The nozzle can be a separate part or integrated with the substrate chip. The individual substrate chips can be produced from a larger substrate plate. The individual nozzle chips can be produced from a composite larger plate comprising a substrate plate and a lid.

Substrate

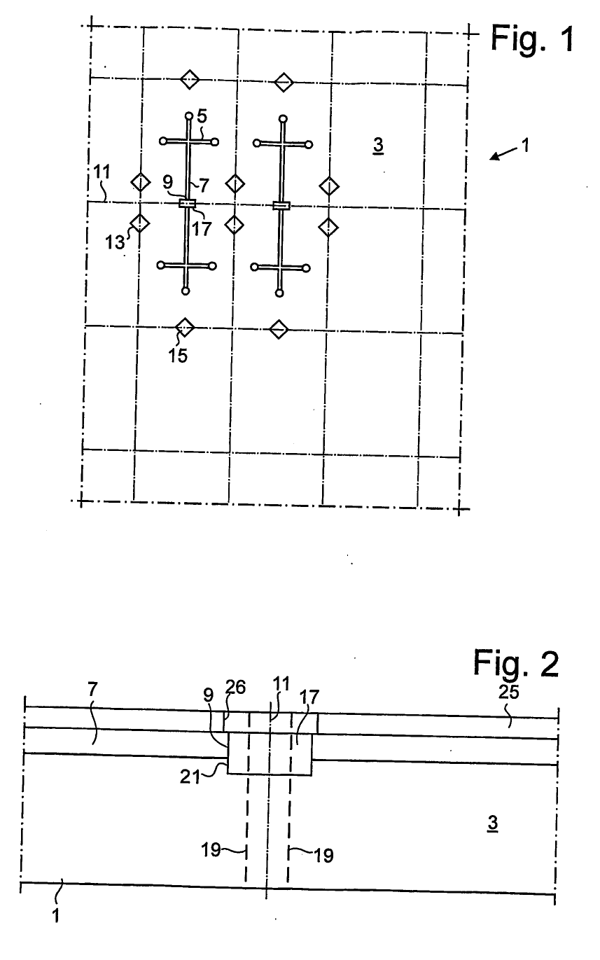

In FIG. 1 a segment of a polymer plate 1 is shown that is used for producing substrate chips or carriers for electrospray nozzle chips. The plate is produced by shaping or moulding some suitable polymer material, typically COP, COC, PC, PMMA or PS, e.g. COP from Zeonor, such as by injection moulding a thermoplastic material. Also, a replication or embossing method can be used. The plate 1 comprises a multitude of areas 3 that will form substrate chips 3′ being the rigid part of the nozzles. In each of the areas recesses or grooves are moulded that form inlets channels 5 for receiving liquids to be analyzed and an outlet channel 7. The end 9 of the outlet channel forms an outlet opening for the liquid, that can be the very nozzle from which liquid is expelled. In other embodiments a separate nozzle part will be attached at the end of the outlet channel 7. The outlet opening has three sides which are well defined in the case where they been produced in a moulding or replication operation and not by any abrasive or cutting operation.

The plate 1 is divided, e.g. by sawing, milling or punching, at splitting lines 11 to produce the separate substrate chips. The dividing of the plate can also be accomplished by providing it, in the shaping or moulding operation, with separation grooves along which the plate can be easily broken. Also, the plate can be produced on some base plate, not shown, so that the individual chips are produced in the shaping or moulding operation. In that case, in the shaping or moulding operation the plate is provided with delimiting separation channels extending from the surface of the plate down to the base plate. After finishing the production of the chip structures, the individual chips are finally separated from the base plate.

At the splitting lines 11 other recesses 13, 15 are made which act as alignment devices and will be used for mounting the separated chips in accurate positions. Such recesses can be made to have a square shape, a diagonal line of the square located along a splitting line 11. After splitting into separate chips the recesses will then have a triangular shape as seen from above. As seen from the edges of the separate substrate chips they have a short V-groove shape.

The substrate chips generally have a rectangular shape. The outlet opening 9 can be located at a short side of the rectangular shape and then the alignment recesses can located so that one recess 13 is placed on each long side, at a position displaced some distance from the center of the respective sides towards the short side at the exit opening. The other, opposite short side can carry one alignment recess 15 that is located centrally on the side.

Due to the fact that the alignment recesses and the outlet opening are formed in the same shaping or moulding step, they can be given accurate relative positions so that the finished nozzle chip can be mounted in a reproducible way in a mass spectrometer.

For an edge emitting nozzle chip the outlet opening 9 is formed in another recess 17 at the respective side of the area that will form a chip. This recess is given such a width in a direction from the respective splitting line 11 that the outermost portions of or the surfaces at the outlet opening are not affected when splitting the original large moulded plate 1 into separate chips, see FIG. 2, where the material removed in a dicing operation is shown as the area between the lines 19. In particular the inner sidewall 21 of the recess 17 is not affected.

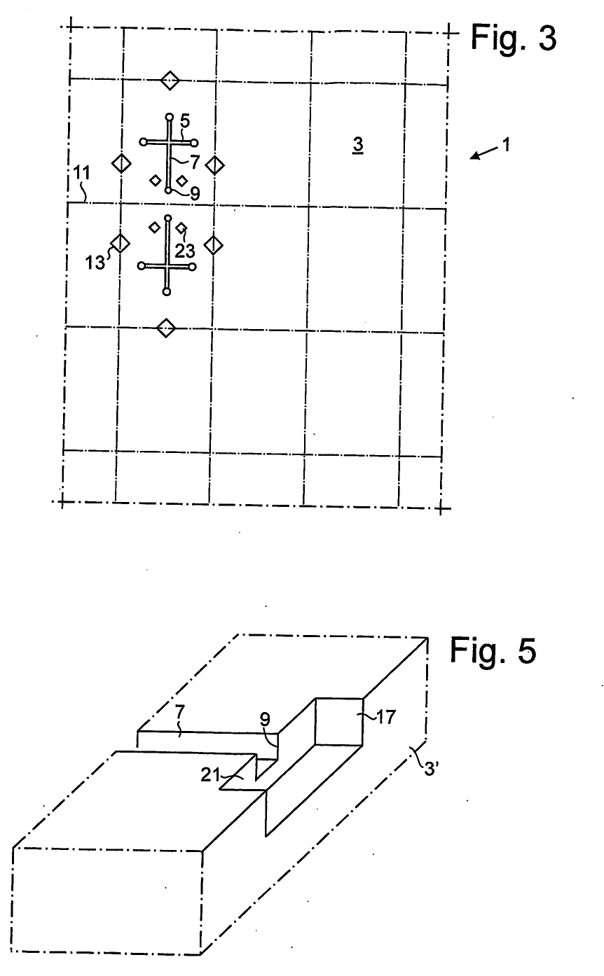

For a surface emitting nozzle chip, see FIG. 3, projections or mesas 23 or other alignment devices such as alignment marks in the form of crossed lines, formed by grooves, not shown, can be provided on the surface of the substrate to accurately position the separate nozzle part as will be described below.

The mould used for the producing the large plate 1 can be produced by first producing a model of the desired structure made from silicon processed using the common methods of silicon processing as used for manufacturing microelectronic circuits and other microdevices. Then, in a second step the model is coated such as by electroplating to produce a metal mould. Finally the silicon is removed such as by some etching method.

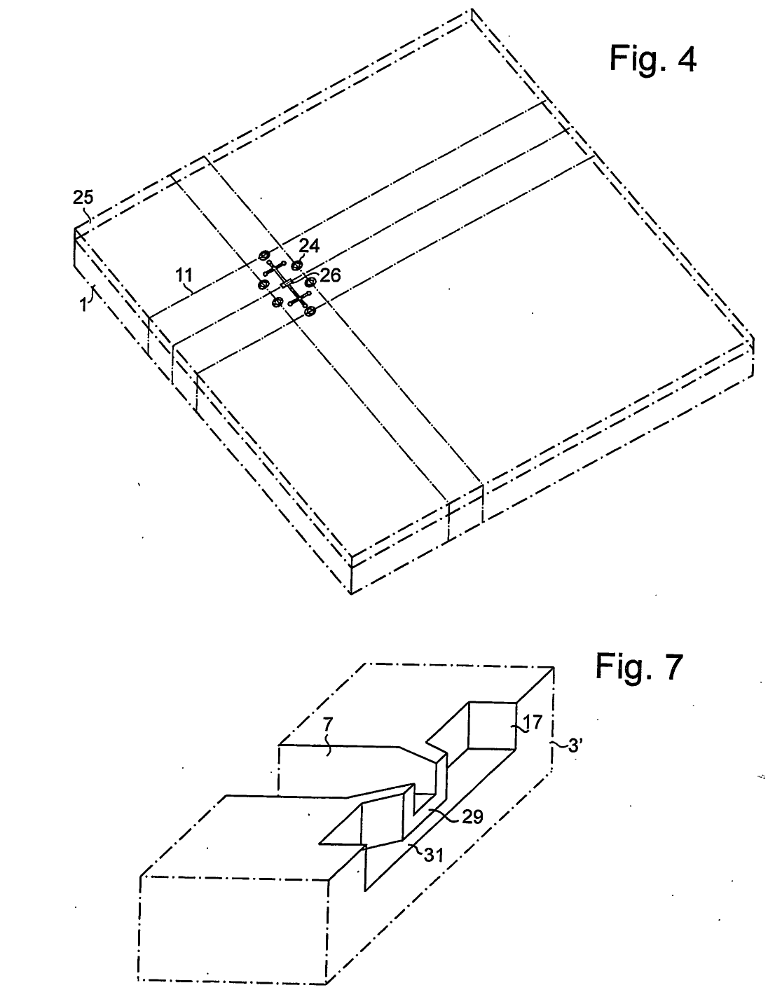

After the large plate 1 has been shaped or moulded the recesses forming channels in the surface of the plate are closed, see FIG. 4, by attaching a lid 25, e.g. a thin polymer film or laminate 25 of a thickness about 40 μm, typically of PET, PC or PMMA, such as a PET laminate, to the surface of the substrate in which all the recesses are made, the lid forming the roof or upper surface of the channels formed as seen in the figure. Finally, the produced composite plate is separated into individual chips, each area 3 forming a nozzle chip. The chips can now be ready for use but in some case they will require additional processing such as attaching a separate nozzle.

The lid 25 can have through-holes 24, 26 made at appropriate places to expose the alignment means such as the recesses 13, 15 and the recesses 17 at the outlet openings 9 in the substrate plate illustrated in FIG. 1.

It is obvious that the substrate chips formed from the areas 3 of plate 1 also can be produced individually, by only shaping or moulding one or a few substrate chips at a time.

It is also obvious that each of the nozzle chips can comprise a plurality of channel systems and associated outlet channels and outlet openings including the nozzles, the outlet channels e.g. extending in parallel to each other and the outlet openings located at a common edge of the chip.

Edge Emitting Chip

Now an edge emitting nozzle chip having a polymer opening or tip will be described. In the recesses 17, see FIG. 1, formed in separated areas 3 of the substrate 1 at the exit openings 9 different structures can be made.

In a first case, the outlet channel can end or mouth directly in the inner, flat sidewall 21 of the recess as seen in FIG. 2 and also in the perspective view of FIG. 5.

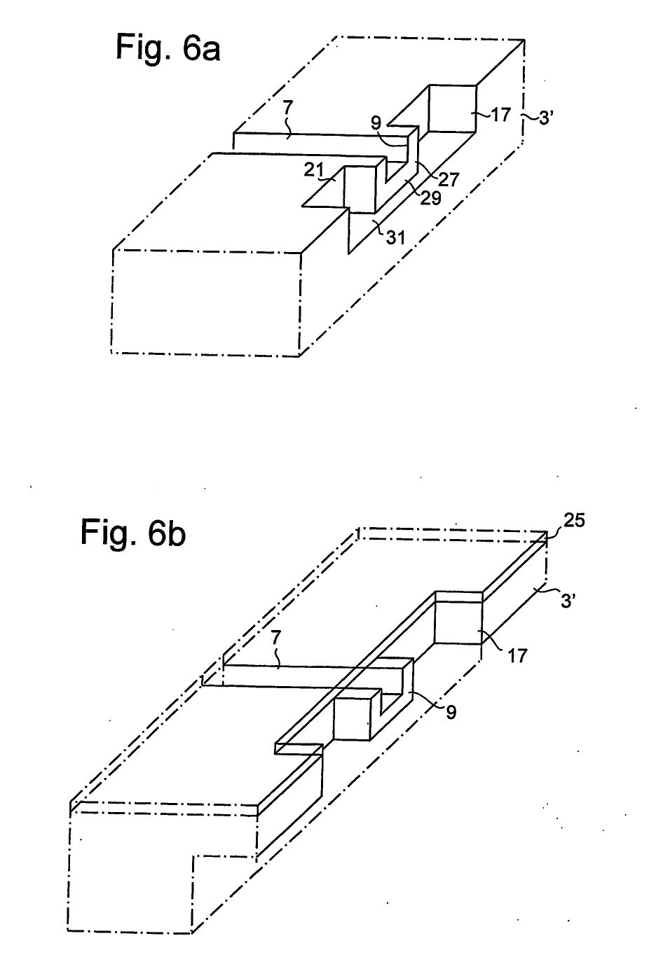

In a second case, the outlet channel has one or more parts projecting from the inner flat sidewall 21 of the recess 17. These parts can form three walls 27, 29 of a spout, that can extend perpendicularly to said sidewall or be tapering, as seen in FIGS. 6a and 7 respectively. For tapering walls the outlet channel can also be tapering. The bottom projecting part 29 is connected to the bottom surface 31 of the recess.

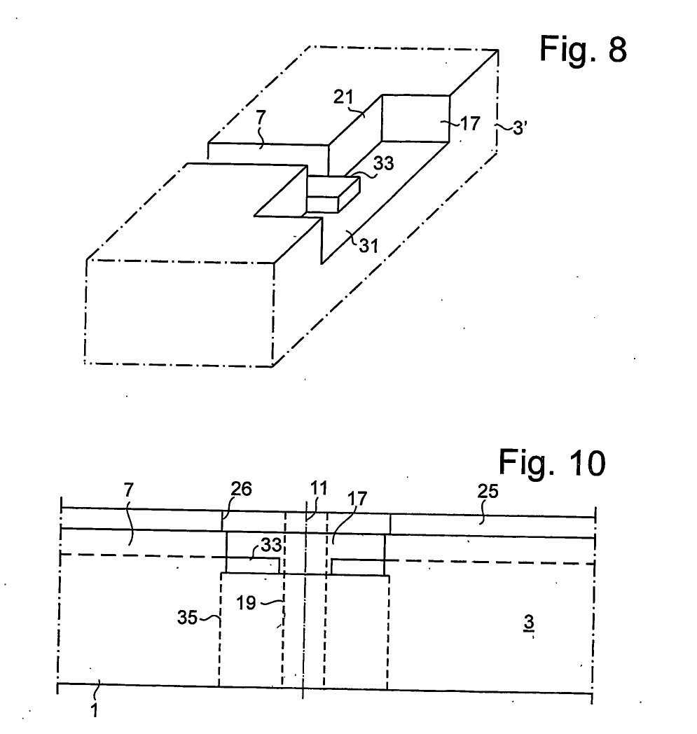

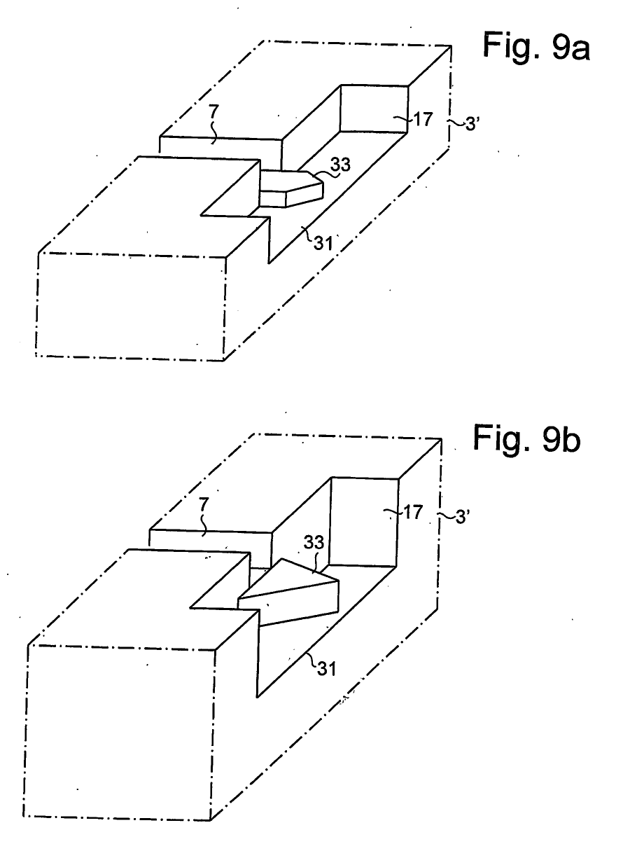

Also, as seen in FIGS. 8, 9a and 9b there can be only a projecting part 33 at the bottom surface of the outlet channel 9, this projecting part then being a continuation of said bottom surface and connected to the bottom surface of the 31 of the recess. The projecting part can have a rectangular shape, see FIG. 8, or have a triangular shape, at least at its outermost portion, see FIGS. 9a and 9b. The triangle can be symmetric or isosceles having a top angle of at most about 90°.

The lower projecting part 29, 33 can generally rest at, i.e. be connected to, the bottom 31 of the recess 17 when shaping or moulding the substrate plate 1. This design can have drawbacks due to the fact that liquid can adhere to the front or vertical surfaces of the projecting parts and flow therealong. However, the lower projecting part can be made to be freely extending, having a free bottom surface to form a nozzle having the shape of a spout formed by three walls. This can be achieved in an extra milling or sawing step, removing material of the substrate below the lower projecting part, see FIG. 6b. In the case where the chips are produced from a large substrate plate, it can also be made in the step of splitting the large moulded plate, such as by using a specially designed milling or sawing tool having a profiled cutting edge or in extra sawing steps where the circular saw blade is operated with a reduced saw depth. This is illustrated in FIG. 10 where the plate is first sawed to remove material inside the lines 35 and then a composite plate is split at the splitting lines 11 in a final sawing step.

The edge emitting chips can also have metal tips acting as electrodes and in particular as means for guiding the liquid to be analyzed to the outermost point of the tip where it is released to form the desired drops of the Taylor cone. The substrate plate 1 has then the general shape illustrated in FIGS. 1 and 5. Thus the recesses on its surface form channels for receiving a liquid and conducting it to outlet openings 9 at the splitting lines 11, i.e. edges of the separated chips. Each of the outlet openings is located in a recess as above. The polymer lid 25 such as a thin polymer film or laminate is attached to the surface of the plate 1 in which the recesses are made, the lid forming the bottom surface of the channels as seen in FIG. 1. A patterned metal film 41 or foil or sheet 43 is located between the substrate plate and the polymer film. The metal film or sheet has the shape of a strip that is provided with a tip and is located so that is forms the bottom of the channel ending in the outlet opening. The tip 45 of the metal strip has generally the shape of an isosceles triangle, the base of the triangle continuing into or connected to the portion of the metal area having a constant width. The angles of the tip area at the base of the triangle shape are acute and can be made smaller than 45° by making the two equal sides of the triangle curved to give them a concave shape, and thereby also the top angle of the triangle can be made to be smaller than 45°.

The metal strip is placed so that the outermost portion 47 of the tip is located outside the outlet opening 9. The outermost portion has then a free surface also having an isosceles triangle shape, preferably having base angles and a top angle smaller than 45° due to the concave shape of the equal sides. Such a shape have advantages by the fact that liquid flowing in the channel out through the outlet opening will follow the metal because of its hydrophilic properties and then when exiting the outlet opening will be directed to the acute point 49 of the tip 47 and not leaking towards the sides or laterally along the inner side wall 21 of the recess 17 and past the regions of the triangle shape at the angles at the base of the free triangular shape, due to the small base angles.

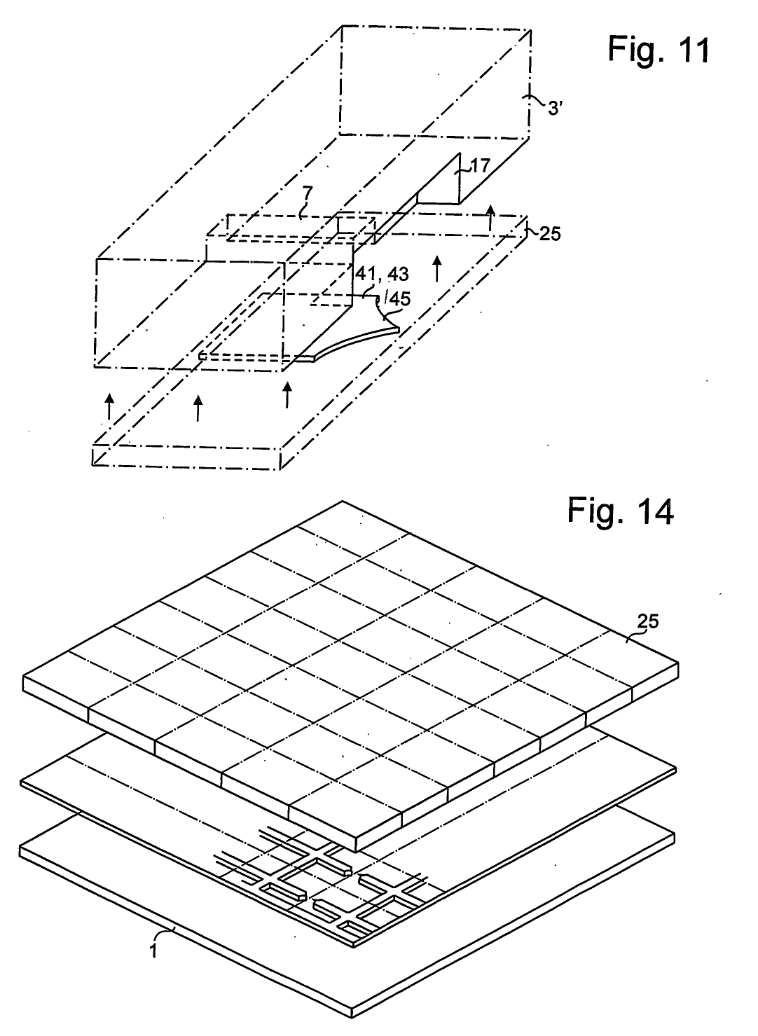

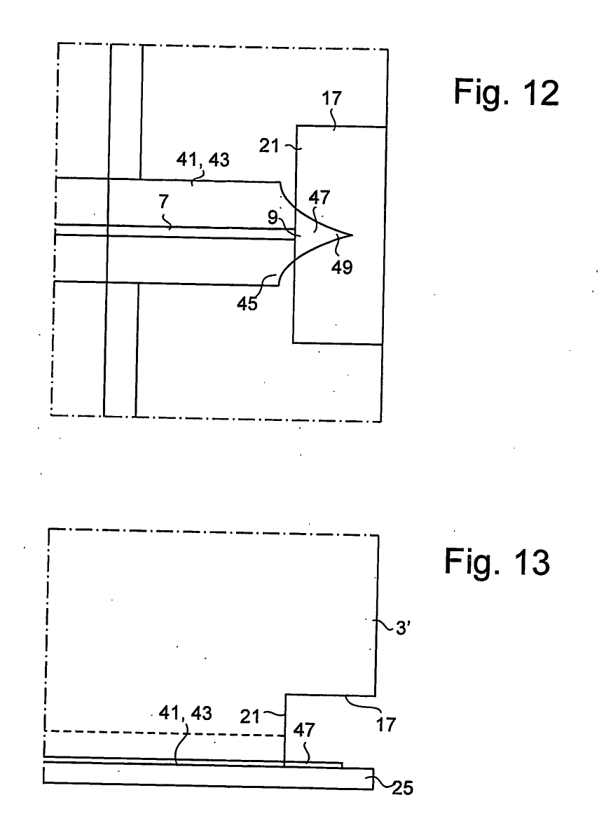

In a first embodiment the metal strip 41 is produced by a lithographic process by first applying a metal layer or film to a surface of the polymer lid 25 and then patterning the metal to form all the metal areas required for the plate 1 to produce a multitude of individual nozzle chips. The polymer lid is then, at its surface where the metal is located, thermally or adhesively bonded to the relevant surface of the substrate. After splitting the composite plate into individual chips, compare FIGS. 11 and 13, a portion of the polymer lid 25 on the chips will project from the inner sidewall of the recess 17. On the inner surface of this free portion of the polymer lid the free area 47 of the metal tip is located.

In a second embodiment, see FIG. 14, the metal strip is produced from a thin metal foil which is given the desired outline by etching, e.g. in the same way as leadframes for connection of microelectronic devices are manufactured. A metal sheet having a pattern for the multitude of the individual chips to be produced, one metal strip arranged for each chip, is placed between the substrate and the polymer lid and the combined parts of the assembly formed are attached to each other by e.g. lamination. Suitable bridges can interconnect the metal strips in order to allow the handling of the metal sheet. The composite plate is split and chips having a front configuration are obtained like that obtained in the embodiment using a metal pattern on the polymer sheet.

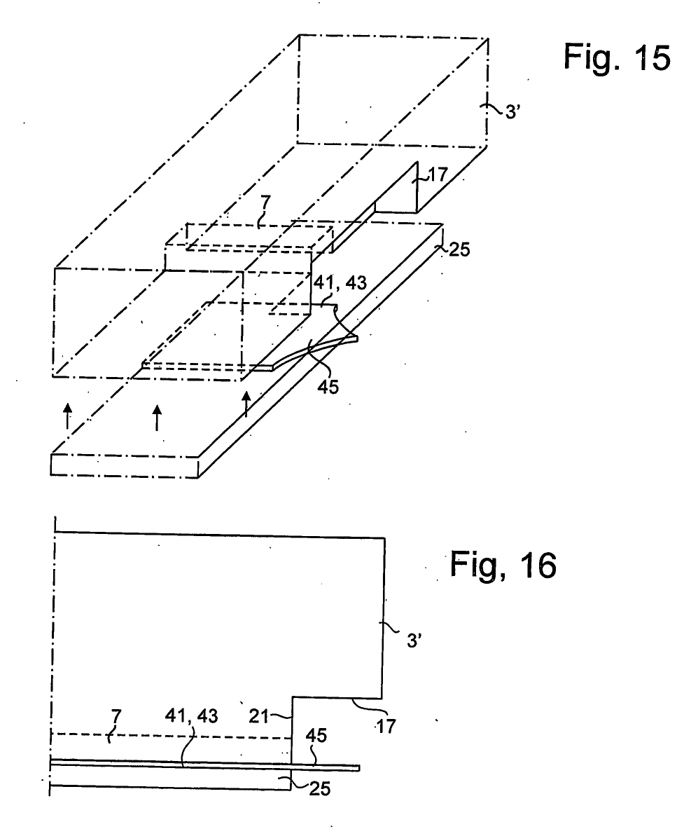

Alternatively, metal strips can be individually produced before laminating, e.g. by splitting the patterned metal foil as seen in FIG. 14. Also the substrates can be individually produced, as has been mentioned above. Then the metal strips can be placed, se FIGS. 15 and 16, so that the tips of the metal strips project freely from the edge of the formed electrospray chips, also beyond the edge of the polymer lid attached to the substrate, since the strips do not require any support. However, the position of the point of the tip is not very well defined in this case. A recess can be provided at the edge of the substrate surrounding the outlet opening and a matching recess at the edge of the polymer lid.

The structure illustrated in FIGS. 15 and 16 in which the outermost portion of the metal tip is freely suspended, not supported by any material, can also be obtained using the methods including a polymer sheet having a metal pattern and a patterned metal foil covering a large substrate plate. Then from the edge of the chips produced, material is removed around the outlet opening by some suitable method, such as a plasma ablation method, removing material from the edge in a direction parallel to the surface of the chips and to the outlet channels. The method can be chosen so that it attacks the material of the polymer lid more easily than the material of the substrate.

Surface Emitting Chip

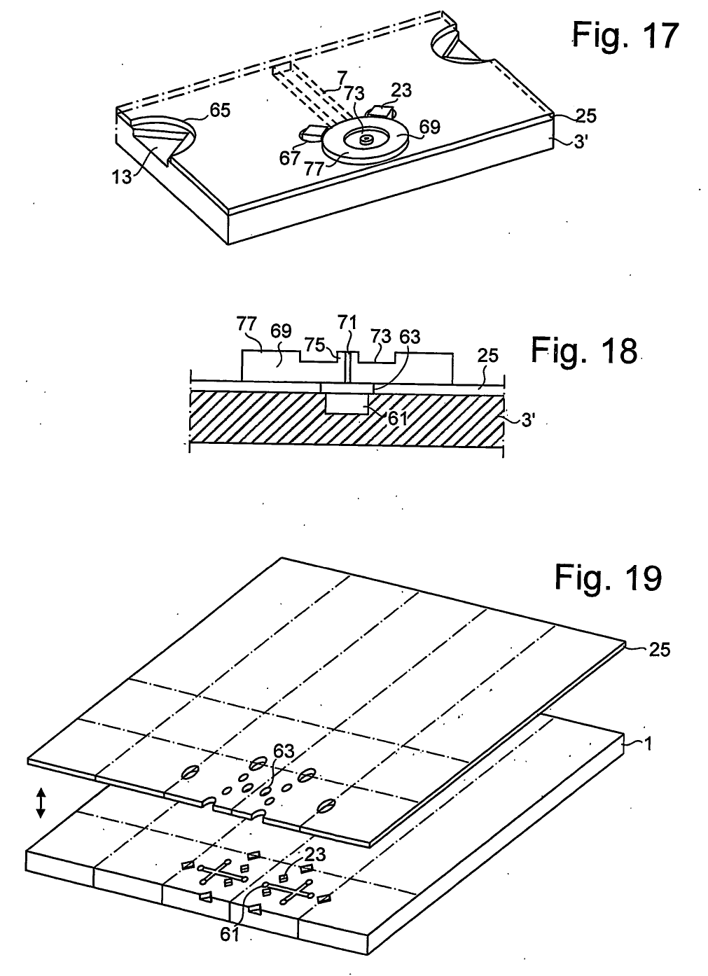

First a carrier or substrate plate 1 is produced as described above with reference to FIG. 3. The substrate has in each area that will form a substrate for an individual chip, recesses on its top surface forming channels for receiving a liquid and conducting along an outlet channel 7 it to an outlet recess 61 e.g. having cylindrical shape, see FIGS. 17, 18 and 19. A polymer lid 25 such as a thermoplastic polymer laminate film is attached to the top surface closing the channels and having for each chip a cut-out 63, that e.g. has a circular shape matching the outlet recess and is placed directly on top thereof so that liquid can flow through the outlet recess and through the associated cut-out. These cut-outs 63 can have a diameter slightly larger than that of the outlet recess 61 in order not to require a too accurate positioning or alignment of the lid. The polymer lid 25 can as described above be attached by laminating, i.e. by pressing it firmly in heat towards the top surface of the substrate, for a suitable choice of material in the lid which can be thermoplastic or at least have a thermoplastic bottom or exterior layer. It can also be attached by gluing, i.e. by coating its bottom surface or the top surface of the substrate with a suitable adhesive, e.g. a curable adhesive, and then pressing the lid sheet to the top surface in suitable conditions, e.g. in an elevated temperature for an adhesive that is curable in heat.

The polymer lid 25 also has cut-outs or windows 65, 67 for the alignment recesses 13 adapted for alignment of the substrate of each chip and for the mesas 23 for mounting the separate nozzle parts, in the case where they have been produced in the substrate.

The nozzle 69 is a separate part that has a central through-hole 71 forming the actual outlet opening. Around the central hole a concentric recess 73 is provided that is at its inner edge bounded by a protruding substantially cylindrical portion 75 forming a spout at the outlet opening and that at its outer edge is bounded by an outer circular ridge 77.

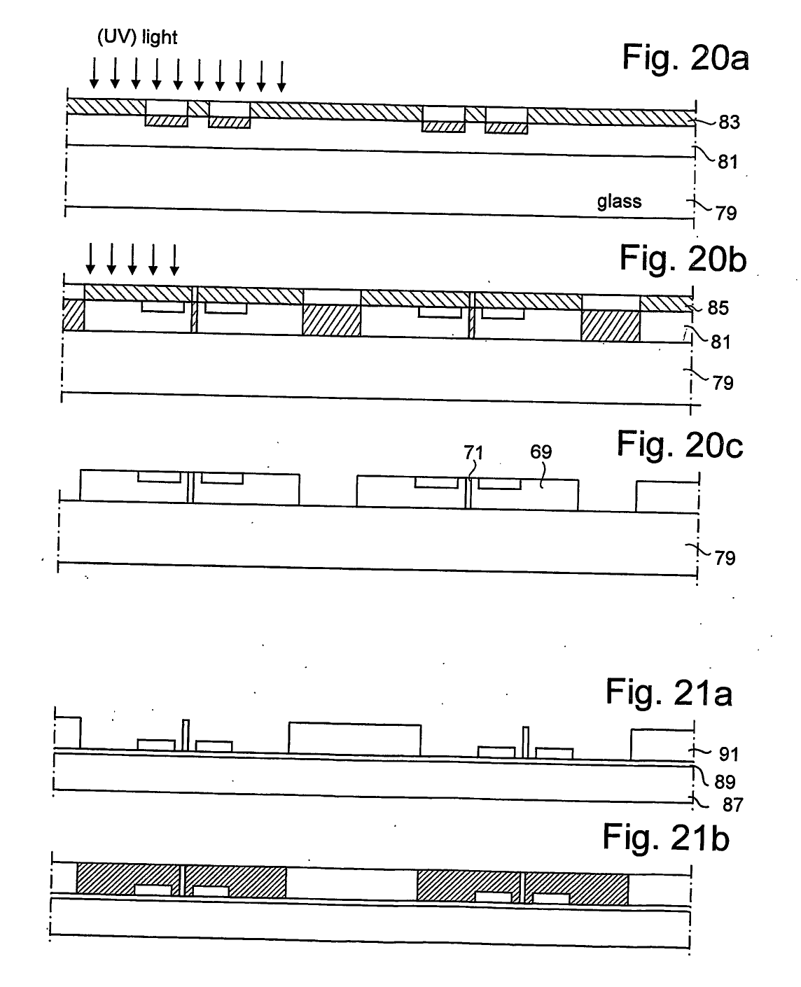

The nozzles 69 can be produced in a UV-lithography process using e.g. a thick epoxy resist such as SU8, in two steps which are necessary for making the recessed structure. Such a process is illustrated in FIGS. 20a-20c. A carrier plate 79 such as a silicon wafer is coated with a layer 81 of a negative photoresist, e.g. by spinning. A suitably patterned mask plate 83 is placed over the free surface of the photoresist layer and light is applied to pass through the mask plate into the top surface layer of the photoresist, see FIG. 20a. The surface is illuminated for an adapted time period to only affect the top surface layer. The mask plate is removed and the portions affected by the light are cleaned away to produce the surrounding recesses 73. Then as seen in FIG. 20b another mask plate 85 having a different pattern is placed over the photoresist layer 81 and is illuminated with suitable light for such a long period that all the material of the photoresist layer under the openings in the mask plate is affected. The mask plate is removed and the affected portions are cleaned away to produce the outlet channels 71 and delimiting the nozzles 69 from each, other, see FIG. 20c. Finally the produced nozzles are detached from the carrier plate 79.

The nozzles 69 can then be surface mounted using an adhesive to firmly attach them to the surface of the combined structure including the areas of the substrate 1 as a bottom layer and the polymer layer 25 on top of thereof.

The separate nozzles can also be made from metal using an electroforming or electroplating method, see FIGS. 21a and 21b. Then first a tool is produced, see FIG. 21a, including a substrate 87 from a suitable material such as a silicon wafer that is coated with a thin top metal layer 89, e.g. of Ti. On the top metal layer a polymer layer 91 is applied and patterned in two steps, e.g. in basically the same way as described above, to produce a mould having a negative shape in e.g. in basically the same way as described above, to produce a mould having a negative shape in relation to the nozzles to be formed. Thereupon the surface is electrochemically plated with typically Ni, see FIG. 21b. In the plating process first only the exposed, free metal surfaces are coated and the metal layer grows in height. When it has reached the height of the polymer parts that form bottoms of the recesses 73 surrounding the outlet opening it starts to grow over the top surfaces of these polymer parts to finally form a continuous layer of the top surfaces. The growth of the metal layer is stopped before it reaches the height of the polymer portions forming the outer boundary or delimitation of the nozzles. Finally, the top layers are separated from the silicon wafer and possible polymer material remaining in the metal parts form is removed such as by burning. Also, some suitable etching agent can be used.

It should be understood herein and in the claims hereof that such terms as “top”, “bottom”, “upwardly”, “downwordly”, “front”, “rear” and the like have been used for illustration purposes only, in order to provide a clear and understandable description and claiming of the invention. Such terms are not in any way to be construed as limiting, because the devices of invention are omni-directional in use as can be understood by their various uses in different application fields.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

1. A nozzle chip for ejecting a liquid, in particular for an electrospray device, comprising
a substrate having at least one groove on a top surface, the groove ending at an outlet end,
a lid attached to the top surface closing the groove to form a channel that is open at the outlet end,
a nozzle formed at or attached to the outlet end, the nozzle having an outlet opening, characterized by alignment recesses made in or from edges of the substrate and accurately positioned in relation to the outlet opening.

2. A nozzle chip according to claim 1, characterized in that the lid has through-holes at the alignment recesses, the through-holes of the lid being larger than and covering the alignment recesses.

3. A nozzle chip according to claim 1, characterized by a nozzle recess made from the top surface at an edge of the substrate, the nozzle located in the nozzle recess to have its outermost surfaces located inside a straight line or a plane at the edge, the plane being perpendicular to the top surface and the straight line or plane passing through the edge.

4. A nozzle chip according to claim 1, characterized by a metal area in and/or at the nozzle, the metal area having a point from which liquid can leave the outlet opening at a defined location.

5. A nozzle chip according to claim 1, characterized by a nozzle part attached to the polymer lid at the outlet end, the nozzle part forming the nozzle.

6. A nozzle chip for ejecting a liquid, in particular for an electrospray device, comprising
a substrate having at least one groove on a top surface, the groove ending at an outlet end,
a lid attached to the top surface closing the groove to form a channel that is open at the outlet end,
a nozzle formed at or attached to the outlet end, the nozzle having an outlet opening, characterized by a nozzle recess made from the top surface at an edge of the substrate, the nozzle located in the nozzle recess to have its outermost surfaces located inside a straight line or a plane at the edge, the plane being perpendicular to the top surface and the straight line or plane passing through the edge.

7. A nozzle chip according to claim 6, characterized in that the nozzle includes two sidewalls, projecting from an inner wall of the nozzle recess and a bottom wall connected to the bottom of the nozzle recess.

8. A nozzle chip according to claim 6, characterized in that the nozzle includes three walls, two sidewalls and a bottom wall, the three walls forming a spout projecting from an inner wall of the nozzle recess.

9. A nozzle chip according to claim 7, characterized in that the bottom wall is a top surface of a bottom plate extending from an inner wall of the nozzle recess, the bottom plate having a width substantially agreeing with the width of the channel at the end thereof at the end of the sidewalls so that the top surface of the bottom plate forms a continuation of the bottom surface of the channel at its outlet end.

10. A nozzle chip according to claim 9, characterized in that the bottom plate is a rectangular block or plate or has the shape of a triangular block or has a shape being a combination thereof, so that the top surface of the bottom plate is a rectangle or a triangle or is a triangle juxtaposed to a rectangle, the triangle having a corner forming a point from which liquid can leave the outlet opening at a defined location.

11. A nozzle chip according to claim 6, characterized in that the bottom wall has a top surface having a rectangular or triangular shape or a shape comprising a triangle juxtaposed to a rectangle, the triangle having a corner forming a point from which liquid can leave the outlet opening at a defined location.

12. A nozzle chip for ejecting a liquid, in particular for an electrospray device, comprising
a substrate having at least one groove on a top surface, the groove ending at an outlet end,
a lid attached to the top surface closing the groove to form a channel that is open at the outlet end,
a nozzle formed at or attached to the outlet end, the nozzle having an outlet opening, characterized by a metal area in and/or the nozzle, the metal area having a point from which liquid can leave the outlet opening at a defined location.

13. A nozzle chip according to claim 12, characterized in that the metal area has a flat top surface forming a wall of the outlet opening.

14. A nozzle chip according to claim 12, characterized in that the metal area extends between the substrate and the lid forming a top wall of the channel at the outlet end thereof.

15. A nozzle chip according to claim 14, characterized in that the metal area has the shape of a strip having a substantially triangular shape at one end, the free corner of the triangular shape being said point.

16. A nozzle chip according to claim 12, characterized in that the metal area includes a portion of a substantially triangular shape, a corner of the triangular shape being said point, the sides of the triangular shape connected to the free corner having a concave shape so that angles of the triangular shape where it extends from an edge surface of the substrate are at most 45°.

17. A nozzle chip for ejecting a liquid, in particular for an electrospray device, comprising
a substrate having at least one groove on a top surface, the groove ending at an outlet end,
a polymer lid attached to the top surface closing the groove to form a channel that is open at the outlet end,
a nozzle being formed at or attached to the outlet end, the nozzle having an outlet opening, characterized by a nozzle part attached to the polymer lid at the outlet end, the nozzle part forming the nozzle.

18. A nozzle chip according to claim 17, characterized in that the outlet end is located separated from edges of the substrate, the nozzle attached to the free surface of the polymer lid.

19. A nozzle chip according to claim 17, characterized by alignment mesas on the substrate projecting through holes in the polymer lid, the nozzle part being engaged with side surfaces of the mesas to be accurately positioned.

20. A nozzle chip according to claim 17, characterized in that the nozzle part includes a central through-hole forming at an exterior end the outlet opening, the central hole formed in a central part projecting from a base portion of the nozzle part to form a spout.

21. A nozzle chip according to claim 20, characterized in that the central part is surrounded by a concentric ridge having the same height as the central part.

22. A nozzle chip according to claim 17, characterized in that the nozzle part is made from metal.

23. (canceled)

24. (canceled)

25. (canceled)

26. A method of manufacturing a nozzle chip for ejecting a liquid, in particular for an electrospray device, the method comprising the steps of:
producing a substrate having at least one groove on a top surface, the groove ending at an outlet end,
attaching a lid to the top surface closing the groove to form a channel that is open at the outlet end,
forming or attaching a nozzle at or to the outlet end, the nozzle having an outlet opening, characterized in that in the step of producing the substrate, alignment recesses are made in or from edges of the substrate to allow a accurate positioning of the nozzle chip in relation to the outlet opening.
